(19) United States
(12) Patent Application Publication
(10) Pub. No.: US 2026/0322726 A1
(43) Pub. Date: Oct. 15, 2026

(54) METHOD AND DEVICE FOR MEASURING SIGNAL BASED ON PRIORITY OF SIGNAL

(71) Applicant: Samsung Electronics Co., Ltd., Suwon-si, Gyeonggi-do (KR)

(72) Inventors: Pengru LI, Beijing (CN); Qi XIONG, Beijing (CN); Miao ZHOU, Beijing (CN); Feifei SUN, Beijing (CN)

(21) Appl. No.: 19/108,597

(22) PCT Filed: Sep. 4, 2023
(86) PCT No.: PCT/KR2023/013134

§ 371 Date: Mar. 4, 2025

(30) Foreign Application Priority Data
Sep. 28, 2022 (CN) 202211194248.7

(51) Int. Cl. H04L 43/091; H04W 72/25

(52) U.S. Cl. CPC H04L 43/091; H04W 72/25

(57) ABSTRACT

The disclosure provides a method and device for measuring a signal based on priorities of signals, and discloses a method performed by a first user equipment (UE) in a communication system comprising: receiving configuration information for a first unit used for a first signal measurement; obtaining a priority relationship between a first signal and a second signal and/or channel, and/or obtaining a priority between the first signal of a second UE and the first signal of a third UE; and measuring the first signal in the first unit based on the determined priority relationship.

### TECHNICAL FIELD

The present disclosure relates to a wireless communication technology, and more particularly, to a method and device for measuring a signal based on priorities of signals.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

In order to meet the increasing demand for wireless data communication services since the deployment of 4G communication systems, efforts have been made to develop improved 5G or pre- 5G communication systems. Therefore, 5G or pre- 5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

### DISCLOSURE OF INVENTION

### Solution to Problem

A method performed by a first user equipment (UE) in a wireless communication system, comprising: receiving configuration information for a first unit used for a first signal measurement; obtaining a priority relationship between a first signal and a second signal and/or channel, and/or obtaining a priority relationship between the first signal of a second UE and the first signal of a third UE; and measuring the first signal in the first unit based on the determined priority relationship.

A User Equipment (UE) in a wireless communication system, the UE comprising: a transceiver; and a controller coupled with the transceiver and configured to: receive configuration information for a first unit used for a first signal measurement; obtain a priority relationship between a first signal and a second signal and/or channel, and/or obtain a priority relationship between the first signal of a second UE and the first signal of a third UE; and measure the first signal in the first unit based on the determined priority relationship.

### BRIEF DESCRIPTION OF DRAWINGS

FIG. 1 illustrates an example wireless network according to various embodiments of the present disclosure;

FIG. 2A and FIG. 2B illustrate example wireless transmission and reception paths according to the present disclosure;

FIG. 3A illustrates an example User Equipment UE according to the present disclosure;

FIG. 3B illustrates an example base station according to the present disclosure;

FIG. 4 is a flowchart of a method according to an embodiment of the present disclosure;

FIG. 5 illustrates a structure of a UE according to an embodiment of the disclosure; and

FIG. 6 illustrates a structure of a base station according to an embodiment of the disclosure.

### MODE FOR THE INVENTION

There is a need in the prior art to provide a method and device for measuring a signal based on priorities of signals.

According to an aspect of the present disclosure, it is provided a method performed by a first User Equipment (UE) in a communication system, comprising: receiving configuration information for a first unit used for a first signal measurement; obtaining a priority relationship between a first signal and a second signal and/or channel, and/or obtaining a priority relationship between the first signal of a second UE and the first signal of a third UE; and measuring the first signal in the first unit based on the determined priority relationship.

According to the embodiment of the present disclosure, obtaining the priority relationship between the first signal and the second signal and/or channel comprises: the first UE receives information with a priority value of the first signal and information with a priority value of the second signal and/or channel, and determines the priority relationship between the first signal and the second signal and/or channel based on the received information.

According to the embodiment of the present disclosure, the priority relationship between the first signal and the second signal and/or channel comprises: in case that the first UE is able to process the first signal and the second signal and/or channel in parallel, the priority of the first signal is the same as the priority of the second signal and/or channel; or the priority relationship between the first signal and the second signal and/or channel is determined based on a pre-configured priority value of the first signal and a pre-configured priority value of the second signal and/or channel; or the priority relationship between the first signal and the second signal and/or channel is determined based on the received priority value of the first signal and a pre-configured priority value of the second signal and/or channel; or the priority relationship between the first signal and the second signal and/or channel is determined based on the first UE capability; or the priority relationship between the first signal and the second signal and/or channel is based on information on UE capability and the received information with the priority.

According to the embodiment of the present disclosure, determining the priority relationship between the first signal and the second signal and/or channel comprises: the first UE reports channel occupancy information, and determines the priority relationship between the first signal and other signals and/or channels based on the channel occupancy information and a threshold value associated with the channel occupancy in case that the first UE receives the threshold value associated with the channel occupancy; or determines that the first signal is higher priority than other signals and/or channels in case that the UE does not receive the threshold value associated with the channel occupancy.

According to an embodiment of the present disclosure, determining the priority relationship between the first signal and the second signal and/or channel comprises: determining that the first signal is lower priority than the second signal and/or channel; or in case that a threshold value associated with the priority of the second signal and/or channel is received, determining the priority relationship between the first signal and the second signal and/or channel based on the threshold value associated with the priority of the second signal and/or channel and information with the priority value of the first signal; or determining that the first signal is higher priority than the second signal and/or channel in case that the threshold value associated with the priority of the second signal and/or channel is not received; or determining that the first signal is lower priority than the Physical Side Feedback Channel (PSFCH).

According to the embodiment of the present disclosure, a priority value of the first signal of the second UE and a priority value of the first signal of the third UE are configured based on a time order in which requests arrival at network node, and the requests are sent by the second UE and the third UE to configure the first unit; or the priority value of the first signal of the second UE and the priority value of the first signal of the third UE are configured based on moving speeds of the second UE and the third UE; or the priority value of the first signal of the second UE and the priority value of the first signal of the third UE are configured based on time information of the timer corresponding to the first signals of the second UE and the third UE.

According to an embodiment of the present disclosure, measuring the first signal in the first unit based on the determined priority relationship comprises: determining resource for the first signal transmission based on the determined priority relationship, and measuring the determined resource in the first unit.

According to the embodiment of the present disclosure, determining the resource for the first signal transmission based on the determined priority relationship comprises: when the first signal of the second UE is higher priority than the first signal of the third UE and/or the second signal and/or channel, resources reserved for the first signal of the third UE and/or the second signal and/or channel are selected for the first signal of the second UE, and resource re-evaluation of the selected resources is triggered; or when the first signal of the second UE is lower priority than the first signal of the third UE and/or the second signal and/or channel, the resource reserved for the first signal of the second UE is selected for the first signal of the third UE and/or the second signal and/or channel, and the resource re-evaluation of the selected resource is triggered.

According to an embodiment of the present disclosure, determining the resource for the first signal based on the determined priority relationship comprises: when the first signal is lower priority than the second signal and/or channel or the Physical Sidelink Feedback Channel (PSFCH), the resource reserved for the first signal is selected for the second signal and/or channel or the PSFCH, and resource re-evaluation of the selected resource is triggered; or when the first signal is lower priority than all or part of the Physical Sidelink Shared Channel(s) (PSSCH(s)), the resource reserved for the first signal is selected for the PSSCH(s), and resource re-evaluation of the selected resource is triggered; or when the first signal is higher priority than all or part of the PSSCH(s), the resource reserved for all or part of the PSSCH(s) is selected for the first signal, and resource re-evaluation of the selected resource is triggered.

According to the embodiment of the present disclosure, in case that one or more first signals overlap in time with multiple non-overlapped second signals and/or channels: if at least one first signal of the one or more first signals is prioritized over all second signals and/or channels, resources reserved for the multiple non-overlapped second signals and/or channels are selected for the one or more first signals, and resource re-evaluation of the selected resources is triggered; or if at least one second signal and/or channel is prioritized over all first signals, the resources reserved for the one or more first signals are selected for the multiple non-overlapped second signals and/or channels, and resource re-evaluation of the selected resources is triggered.

According to the embodiment of the present disclosure, in case that one first signal overlaps in time with one or more non-overlapped second signals and/or channels: if the one first signal is prioritized over all the second signals and/or channels, resources reserved for the one or more non-overlapped second signals and/or channels are selected for the one first signal, and resource re-evaluation of the selected resources is triggered; if at least one non-overlapped second signal and/or channel of the one or more non-overlapped second signals and/or channels is prioritized over the one first signal, resource reserved for one first signal is selected for the one or more non-overlapped second signals and/or channels, and resource re-evaluation of the selected resources is triggered.

According to an embodiment of the present disclosure, the first signal is a signal or a signal resource or a signal resource set for positioning, wherein the first unit comprises at least one of: a measurement gap for measuring the first signal; a processing window for measuring the first signal; a time domain unit for measuring the first signal; a duration L starting from a starting position S of resources used for the first signal transmission, or a length of time domain resources occupied by M first signals starting from the starting position S of the resources used for the first signal transmission, wherein S, L and M are real numbers greater than 0.

According to the embodiment of the present disclosure, the method further comprises: when the first signal of the second UE overlaps with the first signal of the third UE or the second signal and/or channel in time domain and/or frequency domain resources: in case that the first signal of the second UE is higher priority than the second signal and/or channel or the first signal of the third UE, the first UE is expected to receive the first signal of the second UE; or in case that the first signal is lower priority than the second signal and/or channel, the first UE is expected to receive the second signal and/or channel and/or drop all or part of the first signals; or in case that the first signal of the second UE is lower priority than the first signal of the third UE, the first UE performs at least one of the following: is not required to receive the first signal of the second UE, drop all or part of the first signals of the second UE, extending a measurement duration of the first unit, the first UE indicating the dropped number of first signals of the second UE to the second UE, and the first UE indicating an identify and/or a time domain resource symbol index of the dropped first signal of the second UE to the second UE; or in case that the first signal of the second UE has the same priority as that of the first signal of the third UE, resource is reserved for the first signal of any one of the second UE and the third UE, and the resource re-evaluation of the first signal of the rest UE is triggered, or according to the time of the timer in the configuration information for the first signals of the second UE and the third UE, the resource is reserved for the first signal of the UE with the shortest time of the timer, and the re-evaluation of resource is triggered for the rest UE.

According to the embodiment of the present disclosure, when a ratio of the dropped number of first signals of the second UE to the number of configured or pre-configured first signals of the second UE is greater than a third threshold value, the length L of the measurement duration is extended, wherein the measured first signal does not contain the dropped first signal.

According to the embodiment of the present disclosure, the method further comprises: if the first signal of the second UE is lower priority than the first signal of the third UE, the first signal of the second UE on overlapping time domain resources and/or overlapping frequency domain resources is muted and/or deactivated by the second UE; the second UE configures or activates the same number of the first signals as that of the dropped first signals of the second UE indicated by the first UE, or reserves the same number of the first signals resources as that of the dropped first signals of the second UE indicated by the first UE.

According to the embodiment of the present disclosure, the method further comprises: the first UE reports measurement result of the first signal to a network node, wherein the measurement result is reported on the first Physical Sidelink Shared Channel (PSSCH), or the first Physical Uplink Shared Channel (PUSCH), or the first Physical Sidelink Control Channel (PSCCH), or the first Physical Uplink Control Channel (PUCCH) after the last time unit of the first unit; or in case that the first signal measurement is completed in first N time units of the first unit, the measurement result is reported on the PSSCH or the PUSCH or the PSCCH or the PUCCH before the end of the first unit from the (N+1)th time unit; or in case that the first signal is measured in the Xth first unit, the measurement result is reported after the Xth first unit, wherein X is an integer greater than or equal to 1, and the measurement result comprises measurement result of the Xth first unit; or after measuring the first signal using the last time unit of the first unit, the first UE requests uplink transmission resource, and reports the measurement result through PSSCH or PUSCH or PSCCH or PUCCH on the configured resource.

According to an embodiment of the present disclosure, the measurement result comprises at least one of: received signal strength of measurement path; a downlink angle Of departure of the measurement path; a time difference between the received signals of the measurement paths of a serving cell and a reference cell; a time difference between reception and transmission of the UE.

According to the embodiment of the present disclosure, the priority of the measurement result reporting is the same as the highest priority among the priorities of multiple first signals measured in P first units, wherein P is an integer greater than 1, or in case that the measurement result is obtained based on the measurement of multiple first units, the priority of the measurement result reporting is the same as the highest priority for the first signals in the last first unit in which the measurement is performed.

According to an aspect of the present disclosure, it is provided a User Equipment (UE) in a wireless communication system, which comprises: a transceiver configured to receive and transmit a signal; and a controller coupled with the transceiver and configured to control the UE to perform the method according to the embodiment of the present disclosure.

By the method and the device for measuring signals based on the priorities of signals provided by the disclosure, conflicts between signals can be solved, resources can be reasonably allocated for signals, or signals can be measured quickly and accurately.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

The technical scheme of the embodiment of the disclosure can be applied to various communication systems, such as the Global System for Mobile Communications (GSM) system, Code Division Multiple Access (CDMA), CDMA) system, Wideband Code Division Multiple Access (WCDMA) system, General Packet Radio Service (GPRS), Long Term Evolution (LTE) system, LTE Frequency Division Duplex (FDD) system, LTE Time Division Duplex (TDD), Universal Mobile Telecommunications System (UMTS), Worldwide Interoperability For Microwave Access (WiMAX) communication system, 5th generation (5G) system or New Radio (NR), etc. In addition, the technical scheme of the embodiment of the disclosure can be applied to future-oriented communication technologies, such as 6G.

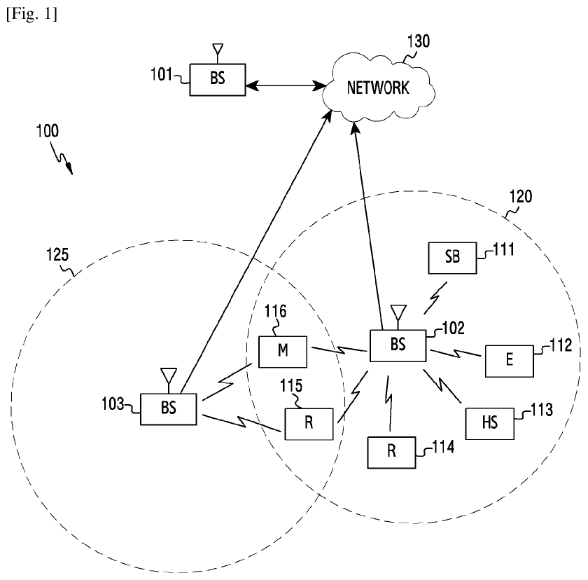

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

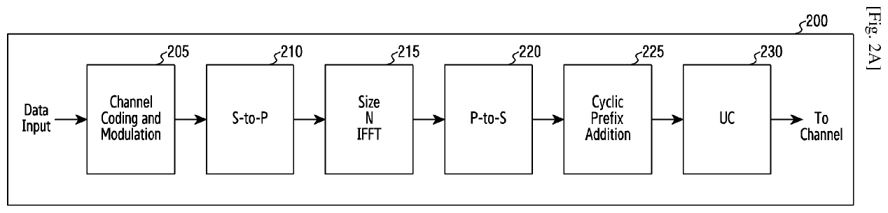

FIGS. 2A and 2B illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

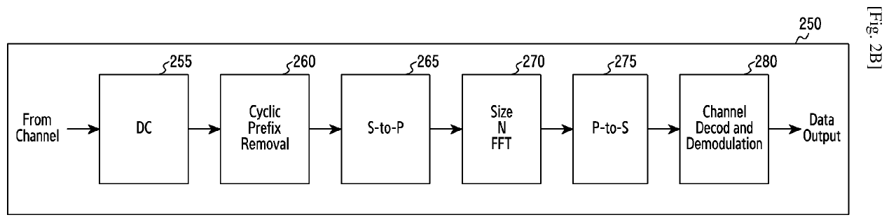

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

A time domain unit (also called time unit) in this disclosure can be an OFDM symbol, an OFDM symbol group (composed of multiple OFDM symbols), a slot, a slot group (composed of multiple slots), a subframe, a subframe group (composed of multiple subframes), a system frame and a system frame group (composed of multiple system frames); it can also be an absolute time unit, such as 1 millisecond, 1 second, etc. A time unit can also be a combination of various granularities, such as N1 slots plus N2 OFDM symbols, where N1 and N2 are positive integers.

A frequency domain unit (also called frequency unit) in this disclosure can be a subcarrier, a subcarrier group (composed of multiple subcarriers), a resource block (RB), also called physical resource block (PRB), a resource block group (composed of multiple RBs), a bandwidth part (BWP), a bandwidth part group (composed of multiple BWPs), a band/carrier, a band group/carrier group; it can also be an absolute frequency domain unit, such as 1 Hz, 1 kHz, etc. The frequency domain unit can also be a combination of multiple granularities, such as M1 PRBs plus M2 subcarriers, where M1 and M2 are positive integers.

In the disclosure, the mentioned “network” may refer to a base station and/or a LMF, and the mentioned “user” may refer to a user equipment (UE).

In the disclosure, ordinal numbers “first”, “second” and “third” are only for clarity of description, and are not intended to limit the order of elements, parts, components or steps, i.e., the first element, part and component and the second element, part or component may also be expressed as the second element, part and component and the first element, part or component.

In the disclosure, the disclosed embodiments are not restrictive, and it should be understood that any two or more of the embodiments and/or features in the embodiments disclosed herein may be combined in any way without departing from the scope of this disclosure.

The exemplary embodiments of the present disclosure are further described below in conjunction with the accompanying drawings.

The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

The transmission links of a wireless communication system mainly includes: downlink communication link from a 5G New Radio (NR) gNB to a user equipment (UE), uplink communication link from a UE to a network, and sidelink (SL) communication link from a UE to a UE, which can also be called a sidelink, etc.

Nodes for positioning measurement in a wireless communication systems, such as the current wireless communication systems, include: a UE that initiates a positioning request message and is used for downlink positioning measurement, a location management function (LMF) that is used for UE positioning and issuing positioning assistance data, a gNB or a transmission-reception point (TRP) that broadcasts positioning assistance data and performs uplink positioning measurement, and a UE that is used for sidelink positioning measurement.

The sidelink resource allocation method can be divided into two modes: one is that the base station allocates sidelink transmission resources to a terminal, that is, Mode 1; the other is that a terminal autonomously selects transmission resources, that is, Mode 2. When using Mode 1 for resource allocation, the base station can dynamically allocate transmission resources for the terminal through downlink control information DCI, or the base station can allocate semi-persistent transmission resources for the terminal, and allocate transmission resources for a positioning signal by means of configured grant (CG) resource allocation. When using Mode 2 for resource allocation, the terminal selects time-frequency resources from the resource pool configured or preconfigured by the network through sensing or random selection, for signal and/or channel transmission. When the user uses sidelink for wireless communication, a problem that needs to be solved is how to perform positioning. As an example, a problem is how to obtain transmission resources for a reference signal for sidelink positioning. As another example, a problem is how to perform measurement of the reference signal based on the sidelink positioning. Among them, the signal for positioning can be, for example, a SL PRS (Positioning Reference Signal), but the name of the signal for positioning is not limited in the present disclosure. In the following contents of the present disclosure, the SL PRS is taken as an example for the purpose of explanation, but is not used for limiting the signal for positioning.

It should be understood that in this disclosure, unless otherwise defined or contradicted by the context, among the UEs described in this disclosure, the UE receiving the SL PRS may be called “a first UE”, and one or more UEs sensing transmission resources and/or transmitting the SL PRS may be called “a second UE” or “a third UE”.

Specifically, the disclosure provides a method and device for determining a signal priority. In an embodiment of the present disclosure, the signal may be signal(s) or signal resource(s) or signal resource set(s) for positioning, wherein the signal for positioning may be, for example, a SLPRS (Positioning Reference Signal), but the naming of the signal for positioning is not limited in the present disclosure. In the following contents of the present disclosure, a SL PRS is taken as an example to explain, but the signal for positioning are not limited. The embodiment of the disclosure discloses a method for determining priority relationship between the SL PRS and other signals and/or channels, a method for determining the priority relationship between the SL PRS and other SL PRSs, a method for reserving one or more time-frequency resources for the SL PRS, determining UE behaviors under different SL PRS priorities, and reporting measurement result of the SL PRS according to priority criteria. In the embodiment of the present disclosure, the SL PRS is used for exemplary introduction, but the introduced method may also be used for measurement of other signals, such as synchronization signal and PBCH block (SSB), channel state information reference signal (CSI-RS) and the like.

A network and/or a UE may configure and/or pre-configure one or more first units for other UEs and/or UE groups to perform SL PRS measurement. The first unit may include one or a combination of more of the following:
a measurement gap for a SL PRS measurement;
a SL PRS processing window for the SL PRS measurement;
a time domain unit for the SL PRS measurement;
duration (length) L from a starting point S of transmission resources;
optionally, if a ratio of the dropped number of SL PRSs to the number of (pre-)configured SL PRSs is greater than a sixth threshold value T5 because the SL PRS is lower priority than other signals and/or channels, the duration (length) L will be extended to C*L, wherein T5 and C are parameter values reported by the user equipment UE according to its own processing capability and/or parameter values configured by the base station which are received by the UE and/or the pre-configured parameter values, and T5 is a real number greater than or equal to 0 and less than or equal to 1, optionally T5=0.5, C is a real number greater than or equal to 1, and optionally, C=1/(1−T5);
M (pre-)configured or measured SL PRS resources starting from the starting point S of the resources, wherein the measured SL PRS resources do not include SL PRS resource(s) dropped due to priority rules;
the starting point S is a first slot index and/or a subframe index and/or a system frame index when the UE starts SL PRS measurement, and the duration (length) L specifies the number of slots and/or the number of subframes and/or the number of system frames and/or the length of time when the UE starts SL PRS measurement from the starting point S;
the M (pre-)configured or measured SL PRS resources starting from the starting point S of the transmission resources may be continuous M SL PRS resources in the time domain or discontinuous M SL PRS resources in the time domain, excluding muted SL PRS resource(s) or resource set(s); and
the starting point S, the duration (length) L and the M SL PRS resources are parameter values reported by the user equipment UE according to its own processing capability and/or parameter values configured by the base station which are received by the UE and/or pre-configured parameter values, wherein S, L and M are real numbers greater than 0.

The other signals and/or channels may include a combination of one or more of the following:
Physical Uplink Control Channel (PUCCH);
Physical Uplink Shared Channel (PUSCH);
Physical Downlink Control Channel (PDCCH);
Physical Downlink Shared Channel (PDSCH);
Physical Broadcast Channel (PBCH);
Physical Random Access Channel (PRACH); and
other sidelink signals and/or channels. The other sidelink signals and/or channels include at least one of the following: Physical Sidelink Control Channel (PSCCH), Physical Sidelink Shared Channel (PSSCH), Physical Sidelink Feedback Channel (PSFCH), Physical Sidelink Broadcast Channel (PSBCH), Sidelink Synchronization Signal (S-SS), Sidelink Channel State Information Reference Signal (SL CSI-RS) and Sidelink Phase Tracking Reference Signal (SL PT-RS).

Through the method of this embodiment, reasonable signal resource allocation and rapid and accurate SL PRS measurement can be realized.

If the UE performs SL PRS measurement in a shared resource pool and/or a dedicated resource pool, optionally, if the UE performs the SL PRS measurement in a first unit configured in the shared resource pool and/or the dedicated resource pool, when reception of the SL PRS and reception or transmission of other signal/channel overlap in time, if the SL PRS is higher priority than other signal/channel, or the priority value of the SL PRS is smaller than the priority value of other signal/channel, the UE is expected to receive the SL PRS; if the SL PRS is lower priority than other signal/channel, or the priority value of the SL PRS is greater than the priority value of other signal/channel, the UE is expected to receive or transmit other signal/channel; if the UE-specific SL PRS is higher priority than the SL PRS of other UE, or the priority value of the UE-specific SL PRS is smaller than the priority value of the SL PRS of other UE, the UE is expected to receive the SL PRS; if the UE-specific SL PRS is lower priority than SL PRS of other UE, or the priority value of the UE-specific SL PRS is greater than the priority value of SL PRS of other UE, the UE does not expect to receive the SL PRS. Based on the determined relationship between the priority of the SL PRS and the priority of other signal/channel, and/or based on the determined relationship between the priority of the UE-specific SL PRS and the priority of the SL PRS of other UE, resources for SL PRS transmission are determined. Here, at least one of a transmitting UE of the SL PRS, a transmitting UE of the UE-specific SL PRS, a transmitting UE of the SL PRS of other UE, or another transmitting UE may transmit the SL PRS. The method for the user to determine the priority of the SL PRS in the first unit may include one or a combination of more of the following:
The UE obtains or determines the priority values of the SL PRS and other signal and/or channel by receiving SCI and/or DCI and/or MAC CE and/or RRC and/or higher layer signaling indication. In the first unit, if the priority value of the SL PRS is smaller than the priority value of other signal and/or channel, the SL PRS is higher priority than other signal and/or channel; or if the priority value of the SL PRS is greater than the priority value of other signal and/or channel, the SL PRS is lower priority than other signals and/or channels; or if the priority value of the SL PRS is smaller than part or all of the priority values of a part of other signals and/or channels, the SL PRS is higher priority than part or all of the part of other signals and/or channels, and if the priority value of the SL PRS is greater than part or all of the priority values of the other part of other signals and/or channels, the SL PRS is lower priority than part or all of the other part of signals and/or channels. Optionally, the UE may indicate by higher layer signaling that if the priority value of SL PRS is smaller than the priority value of all or part of PSSCH(s) in the first unit, the SL PRS is higher priority than all or part of the PSSCH(s); if the priority value of the SL PRS is greater than the priority values of all or another part of PSSCH(s), the SL PRS is lower priority than all or another part of PSSCH(s);
if the UE can process the SL PRS and other signal and/or channel in parallel, the SL PRS and other signal and/or channel have the same priority, i.e., the priority value of the SL PRS is equal to priority value of other signal and/or channel;
The UE reports, to the network, its capability whether it can receive the SL PRS and receive or transmit other signals and/or channels on each frequency band or carrier or non-overlapped OFDM symbols of the UE in the first unit. The capabilities are in one-to-one correspondence with priority options and/or states and/or values, i.e., each PRS processing capability has a unique corresponding priority option and/or state and/or value, the UE can report multiple or multiple kinds of PRS processing capabilities, and the UE determines one PRS processing capability and its corresponding priority option and/or state and/or value by receiving DCI or MAC CE or RRC messages or higher layer signaling indication. In the first unit, if the priority value of the SL PRS is smaller than the priority value of other signal and/or channel, the SL PRS is higher priority than other signal and/or channel; or if the priority value of SL PRS is greater than the priority value of other signal and/or channel, the SL PRS is lower priority than other signals and/or channels; or if the priority value of the SL PRS is smaller than part or all of the priority values of a part of other signals and/or channels, the SL PRS is higher priority than part or all of the part of other signals and/or channels, and if the priority value of the SL PRS is greater than part or all of the priority values of the other part of other signals and/or channels, the SL PRS is lower priority than part or all of the other part of other signals and/or channels; or the priority of the SL PRS is directly determined according to the determined priority option and/or state.
The UE reports the capability to the network that if the UE only supports one priority rule for SL PRS reception and other signals and/or channels reception or transmission, the priorities of the SL PRS and other signals and/or channels can be implied or inferred by the UE capability. For example, the SL PRS is higher priority than other signals and/or channels, i.e., the priority value of SL PRS is smaller than the priority values of other signals and/or channels; or the SL PRS is lower priority than other signals and/or channels, i.e., the priority value of SL PRS is greater than the priority values of other signals and/or channels;
The priority relationship between the SL PRS and other signals and/or channels can be pre-configured. For example, it is predefined that the SL PRS is higher priority than other signals and/or channels, i.e., the priority value of the SL PRS is smaller than the priority values of other signals and/or channels; or it is predefined that the SL PRS is lower priority than other signals and/or channels, i.e., the priority value of SL PRS is greater than the priority values of other signals and/or channels; or the priority of the SL PRS is predefined as one of the priorities of PSSCH transmissions, i.e., if the SL PRS is higher priority than part or all of PSSCHs, the priority value of the SL PRS is smaller than the priority values of part or all of PSSCHs; if the SL PRS is lower priority than another part or all of PSSCHs, the priority value of the SL PRS is greater than the priority values of the another part or all of PSSCHs;
Other UE and/or the network configure the priority relationship between the SL PRS and other signals and/or channels according to a channel busy ratio (CBR) and/or a channel occupancy ratio (CR) of the SL reported by UE. If a first threshold T1 associated with the CBR and/or a second threshold T2 associated with the CR are provided, and the CBR is greater than the first threshold T1 and/or the CR is greater than the second threshold T2, the SL PRS is lower priority than other signals and/or channels, i.e., the priority value of the SL PRS is greater than the priority values of other signals and/or channels; if a first threshold T1 associated with the CBR and/or a second threshold T2 associated with the CR are provided, and the CBR is smaller than the first threshold T1 and/or the CR is smaller than the second threshold T2, the SL PRS is higher priority than other signals and/or channels, i.e., the priority value of SLPRS is smaller than the priority values of other signals and/or channels. If the first threshold T1 associated with the CBR and/or the second four threshold T2 associated with the CR are not provided/are not configured/are absent/are not received, the SL PRS is higher priority than other signals and/or channels, i.e., the priority value of the SL PRS is smaller than the priority values of other signals and/or channels. T1 and T2 are the parameter values reported by the user equipment UE according to its own processing capability and/or the parameter values configured by the base station which are received by the UE and/or pre-configured parameter values, wherein T1 and T2 are real numbers greater than or equal to 0 and less than or equal to 1;
Subject to UE capability and/or an indication of a base station and/or implying by a UE and/or a pre-configured mode, when the SL PRS measurement is performed in the first unit, the other signal and/or channel is higher priority than the SL PRS resource, i.e., the priority value of the SL PRS is greater than the priority value of the other signal and/or channel;
If a third threshold T3 associated with the priority of the other signal and/or channel is provided/configured/present, and if the priority value of SL PRS is smaller than T3, the SL PRS is higher priority than other signal and/or channel; if the third threshold T3 associated with the priority of the other signal and/or channel is provided, and if the priority value of the SL PRS is greater than T3, the SL PRS is lower priority than the other signal and/or channel; if the third threshold T3 associated with the priority of the other signal and/or channel is not provided/not configured/absent/not received, the SL PRS is higher priority than the other signal and/or channel, i.e., the priority value of the SL PRS is smaller than the priority value of the other signal and/or channel. T3 is a parameter value reported by the user equipment UE according to its own processing capability and/or the parameter value configured by the base station which is received by the UE and/or the pre-configured parameter value, wherein T3 is a real number greater than or equal to 0;
Subject to UE capability and/or an indication of a base station and/or implying by a UE and/or a pre-configured mode, when the SL PRS measurement is performed in the first unit, the PSFCH is higher priority than the SL PRS resources, i.e., the priority value of the SL PRS is greater than the priority value of the PSFCH;
As for the priority relationship of SL PRSs among multiple users, when the UE requests SL PRS measurement from other UE and/or the network, optionally, when UE requests other UE and/or network to configure or activate the first unit for SL PRS measurement, according to arrival order of the UCI or MAC CE or RRC of different UEs for requesting to configure or activate the first unit, the network can configure UE-specific priority of the SL PRS for the UE, and configure higher priority of the SL PRS for the UE which requests to configure or activate the first unit earlier in time, i.e., the priority value of the SL PRS of the Ith UE that requests to configure or activate the first unit is I, and the smaller I is, the higher the priority of corresponding SL PRS is, and I is a real number greater than or equal to 0. Through DCI and/or MAC CE and/or RRC and/or higher layer signaling, the priority of the SL PRS of the UE requesting the SL PRS measurement in the current network is indicated, and/or through SCI forwarding, the network determines the priority of the SL PRS of the UE;
According to the priority relationship of SL PRSs among multiple users, the UE can periodically report an instantaneous moving speed to other UEs and/or the network through by assistance information, and other UEs and/or the network configure UE-specific priority of the SL PRS for the UE according to an average moving speed in X ms reported by the UE. If the average moving speed is greater than 0 and smaller than a fourth threshold value V1, the value of the UE-specific priority of the SL PRS is configured as P1; if the average moving speed is greater than the fourth threshold value V1 and smaller than a fifth threshold value V2, the value of the UE-specific priority of the SL PRS is configured as P2; and so on. The higher the average moving speed of the UE in X ms is, the higher the priority of its corresponding SL PRS is. X, P1, P2, V1 and V2 are the parameter values reported by the user equipment UE according to its own processing capability and/or the parameter values configured by the base station which are received by the UE and/or the pre-configured parameter values, wherein X, P1, P2, V1 and V2 are real numbers greater than or equal to 1, and V2 is greater than V1 and P2 is less than P1. Through DCI and/or MAC CE and/or RRC and/or higher layer signaling, the priority of the SL PRS of the UE requesting the SL PRS measurement in the current network is indicated, and/or through SCI forwarding, the network determines the priority of the SL PRS of the UE;
The UE receives configuration parameters of the configured SL PRS from the network, and the configuration parameters of the SL PRS may include time of the timer of the SL PRS, which is used to define the valid time length of the SL PRS configuration. Other UEs and/or the network determine the SL PRS priorities among different users according to the length of the time of the timer of the SL PRS. The shorter the time of the timer of the SL PRS is, the higher the priority of the SL PRS is, and the smaller the priority value of the SL PRS is. Through DCI and/or MAC CE and/or RRC and/or higher layer signaling, the priority of the SL PRS of the UE requesting the SL PRS measurement in the current network is indicated, and/or through SCI forwarding, the network determines the priority of the SL PRS of the UE.

By the method of this embodiment, signal transmission resources can be determined or a conflict between signals can be avoided.

If the UE performs the SL PRS measurement in a shared resource pool and/or a dedicated resource pool, optionally, if the UE performs the SL PRS measurement in the first unit configured in the shared resource pool and/or the dedicated resource pool, one or more UEs may reserve one or more SL PRS time-frequency resources using SCI and/or MAC CE and/or RRC and/or higher layer signaling. The method for reserving the one or more SL PRS time-frequency resources may include one or a combination of more of the following:
If the priority of the SL PRS has been determined, the SL PRS with the high priority can select/pre-empt the time-frequency resource reserved for the SL PRS and/or other signal/channel with the low priority, and the resource re-evaluation for the selected/pre-empted SL PRS and/or other signal/channel with the low priority is triggered;
If the priority of the SL PRS has been determined, other signal/channel with the high priority can select/pre-empt the time-frequency resource reserved for the SL PRS with the low priority, the resource re-evaluation for the selected/pre-empted SL PRS with the low priority is triggered;
Optionally, if the priority of the SL PRS has been determined, the other signal and/or channel with the high priority can select/pre-empt the transmission resource reserved for the SL PRS resources with the low priority, for the other signal and/or channel transmission, so as to reduce latency impact on the other signal and/or channel caused by the SL PRS measurement;
Optionally, if the priority of the SL PRS has been determined, the PSFCH with the high priority can select/pre-empt the transmission resource reserved for the SL PRS resources with the low priority, for feedback of ACK/NACK. This operation is based on greater importance of the feedback of ACK/NACK;
Optionally, subject to UE capability and/or the base station indication, in the first unit for the SL PRS measurement, if the SL PRS is higher priority than all or part of PSSCHs, the SL PRS can select/pre-empt all or part transmission resource reserved for the PSSCH resources with the low priority, and the resource re-evaluation for the selected/pre-empted PSSCHs with the low priority is triggered; if the SL PRS is lower priority than all or part of the PSSCHs, the PSSCHs can select/pre-empt all or part transmission resource reserved for the SL PRS resources with the low priority, and the resource re-evaluation for the selected/pre-empted SL PRS is triggered;
If one or more SL PRSs and multiple other non-overlapped signals and/or channels overlap in time, when at least one SL PRS among the one or more SL PRSs is prioritized over all other signals and/or channels, the one or more SL PRSs can select/pre-empt transmission resources reserved for multiple other non-overlapped signals and/or channels, and the resource re-evaluation of the selected/pre-empted multiple other non-overlapped signals and/or channels is triggered; if one or more SL PRSs and multiple other non-overlapped signals and/or channels overlap in time, when at least one other signal and/or channel in the multiple other non-overlapped signals and/or channels is prioritized over all SL PRSs, the multiple other non-overlapped signals and/or channels can select/pre-empt the transmission resources reserved for the SL PRSs, and the resource re-evaluation selection of the SL PRSs is triggered;
If one SL PRS and one or more other non-overlapped signals and/or channels overlap in time, when the SL PRS is prioritized over all other signals and/or channels, the SL PRS can select/pre-empt the transmission resources reserved for the one or more other non-overlapped signals and/or channels, and the resource re-evaluation of the selected/pre-empted one or more other non-overlapped signals and/or channels is triggered; if one SL PRS and one or more other non-overlapped signals and/or channels overlap in time, when at least one other signal and/or channel among the multiple other non-overlapped signals and/or channels is prioritized over the SL PRS, the one or more other non-overlapped signals and/or channels can select/pre-empt the transmission resources reserved for the SL PRS, and the resource re-evaluation of the selected/pre-empted SL PRS is triggered;
Other UEs and/or the network reserve one or more SL PRS time-frequency resources according to a Channel Busy Ratio (CBR) and/or a Channel Occupancy Ratio (CR) reported by the UE. If the first threshold T1 associated with the CBR and/or the second threshold T2 associated with the CR are provided, and the CBR is greater than the first threshold T1 and/or the CR is greater than the second threshold T2, other signal/channel can select/pre-empt the time-frequency resources reserved for the SL PRS, and the resource re-evaluation of the SL PRS is triggered; if the first threshold T1 associated with the CBR and/or the second threshold T2 associated with the CR are provided, and the CBR is smaller than the first threshold T1 and/or the CR is smaller than the second threshold T2, the SL PRS can select/pre-empt the time-frequency resources reserved for other signal/channel and/or the SL PRS with the low priority, and the resource re-evaluation of other signal/channel and/or the SL PRS with the low priority is triggered;
When the UE requests SL PRS measurement from other UEs and/or the network, optionally, when the UE requests other UEs and/or the network to configure or activate the first unit for the SL PRS measurement, the network can reserve the transmission resource for the UE according to the arrival order of UCI or MAC CE or RRC of different UEs requesting to configure or activate the first unit. The SL PRS of the UE requesting the SL PRS measurement earlier in time can select/pre-empt the transmission resource reserved for the SL PRS of the UE requesting the SL PRS measurement later, and resource re-evaluation of the SL PRS of the UE requesting the SL PRS measurement later is triggered. This scheme is helpful to reduce positioning latency of the UE;
The UE can periodically report an instantaneous moving speed to other UEs and/or the network by assistance information, and other UEs and/or the network reserve SL PRS transmission resources for the UE according to an average moving speed in X ms reported by the UE. The SL PRS of the UE with a high average moving speed can select/pre-empt the transmission resource reserved for the SL PRS of the UE with a low average moving speed, and resource re-evaluation of the SL PRS of the UE with the low average moving speed is triggered. This scheme is helpful to quickly obtain the location information of UE with a high moving speed and reduce the positioning latency;
The configuration parameters of SL PRS may include time of a timer of the SL PRS, which is used to define valid time length of the SL PRS configuration. The UE reserves the SL PRS transmission resource for UE according to the length of timer of SL PRS, and the SL PRS with a short time of the timer can select/pre-empt transmission resource reserved for the SL PRS with a long time of the timer, and resource re-evaluation of the SL PRS with the long time of the timer is triggered.

Subject to UE capability and/or the base station indication, if the SL PRSs of two or more UEs have the same priority, the UE's behaviour may include one or a combination of more of the following:
Up to UE implementation, SL PRS transmission resource is reserved for any UE, for example, the SL PRS transmission resource is reserved for one UE randomly, and resource re-evaluation is triggered for the other UE(s);
According to the time of the timer (timer) of the SL PRS indicated by SCI and/or DCI and/or MAC CE and/or RRC and/or higher layer signaling, by comparing the time of the timer of the SL PRSs of two or more UEs, the SL PRS transmission resource is reserved for the user with the shortest time of the timer, and resource re-evaluation is triggered for other UEs.

When the UE performs SL PRS measurement, optionally, when the UE performs the SL PRS measurement in the first unit, the UE is not expected to measure the SL PRSs configured for other UEs and/or UE group, and only measures the UE-specific SL PRS resource. If the SL PRSs of multiple UEs overlap in time domain and/or frequency domain resource, the UE's behaviour may include one or a combination of more of the following:
On the time-frequency resources of the SL PRSs in which time-domain and/or frequency-domain resources overlapped, a receiving UE drops all or part of the overlapped SL PRSs, and/or extends the measurement duration of the first unit, and/or the receiving UE indicates the dropped number of the SL PRSs to a transmitting UE through SCI, and/or the receiving UE indicates an identity (ID) and/or a time-domain resource symbol index of the dropped SL PRS to the transmitting UE through the SCI;
   Optionally, according to the SL PRS priority indicated by SCI of other UE which is sensed by the SL PRS transmitting UE, when the SL PRS transmitted by the transmitting UE is lower priority than the SL PRS of other UE, the SL PRS transmitting UE can mute and/or deactivate the SL PRS on the overlapped time domain and/or frequency domain resource.
   Optionally, the SL PRS transmitting UE receives the dropped number of SL PRSs indicated by the SL PRS receiving UE through SCI, and the transmitting UE configures or activates the same number of SL PRSs as that of the dropped SL PRSs on the basis of the current SL PRS transmission, or reserves the same number of SL PRS transmission resources as that of the dropped SL PRSs.

Through the method of the embodiment, optimal resource allocation and signal scheduling can be achieved, and a conflict between signals can be avoided.

The way that the UE reports SL PRS measurement result includes one or a combination of more of the following:
The UE reports the measurement result of the SL PRS resource using the first transmitted PSSCH or PUSCH or PSCCH or PUCCH after the last time unit of the first unit for the SL PRS resource measurement.
   Optionally, after the last time unit of the first unit for the SL PRS resource measurement, the receiving UE (for example, the UE outside the coverage of the base station) transmits a request to the transmitting UE (for example, the UE within the coverage of the base station) to apply uplink transmission resources, and the transmitting UE can forward the request to the base station to apply the uplink transmission resources for the receiving UE, or the receiving UE transmits a request to the base station to apply the uplink transmission resources, and the measurement result of SL PRS resource is reported through the transmitted PUSCH.
   Optionally, after the last time unit of the first unit for the SL PRS resource measurement, the receiving UE (for example, the UE outside the coverage of the base station) reports the measurement result of the SL PRS resource to the transmitting UE (for example, the UE within the coverage of the base station) through PSSCH or PSCCH.
   Optionally, after the last time unit of the first unit for the SL PRS resource measurement, the receiving UE directly reports the measurement result of SL PRS resource to the base station through the PUCCH.
Subject to UE capability and/or the network indication, if the corresponding measurement procedure has been completed in the first N time units of the first unit, PSSCH or PUSCH or PSCCH or PUCCH is transmitted before the end of the first unit from the (N+1)th time unit, for the measurement result reporting of SL PRS resource.
The UE uses X first units to measure the SL PRS resources, and reports the measurement result of the SL PRS resources only after the Xth first unit. The measurement result of the SL PRS resources may include measurement results of X first units, or may be an average value, a maximum value or a minimum value of the measurement results of X first units. X is the parameter value reported by the user equipment UE according to its own processing capability and/or the parameter value configured by the base station which is received by the UE and/or the pre-configured parameter value, wherein X is an integer greater than or equal to 1;
Optionally, the first unit may be an activated first unit.

The measurement result of the first unit for SL PRS resource measurement includes at least one or a combination of the following items:
Received signal strength of a measurement path, and the measurement path is defined as including but not limited to a first arrival path, a line of sight path and a strongest power path. The received signal strength may be an average value or a peak value of the received signal strength of all arrival paths within a certain time.
downlink angle of departure of the measurement path, and the measurement path is defined as including but not limited to the first arrival path, the line of sight path and paths received by different antenna connection points.
received signal time difference between the measurement paths of a serving cell and a reference cell, and the measurement path is defined as including but not limited to the first arrival path, the line of sight path and the strongest power path.
UE Rx-Tx time difference, and the UE reception time is defined as including but not limited to arrival time of the first arrival path, line of sight path and the strongest power path, and the UE transmission time is defined as UE uplink signal transmission time closest to the UE reception time.

The method for determining a priority of SL PRS measurement result reporting may include one or a combination of more of the following:
The priority of the SL PRS measurement result reporting is the same as the highest priority of the SL PRS resource among the priorities of multiple SL PRS resources measured in P first units, i.e., the priority value of the SL PRS measurement result reporting is equal to the smallest priority value of the SL PRS resource among multiple SL PRS resources measured in P first units, wherein P is the parameter value reported by the user equipment UE according to its own processing capability and/or the parameter value configured by the base station which is received by the UE and/or the pre-configured parameter value, and is an integer greater than 1.
If the SL PRS measurement result reported by the UE is measured based on multiple first units, the priority of the SL PRS measurement result reporting is the same as the highest priority of the SL PRS resource in the last first unit in which the SL PRS resource measurement is performed, i.e., the priority value of the SL PRS measurement result reporting is equal to the highest priority value of the SL PRS resource in the last first unit in which the SL PRS resource measurement is performed.

By the method of the embodiment, the measurement result can be reported quickly and accurately.

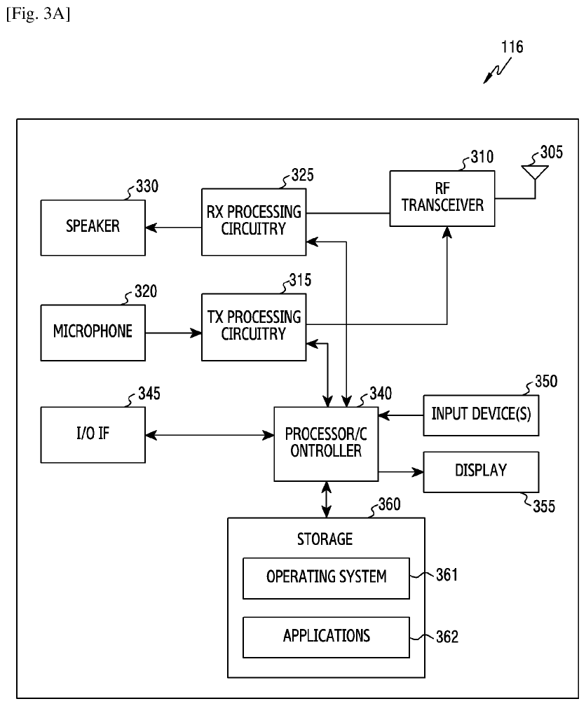

FIG. 4 is a flowchart of a method according to an embodiment of the present disclosure.

Referring to FIG. 4, a method in an embodiment according to the present disclosure is described.

In step S401, configuration information for a first unit used for a first signal measurement is received by a first UE.

In step S402, priority relationship between a first signal and a second signal and/or channel is obtained by the first UE, and/or priority relationship between the first signal of a second UE and the first signal of a third UE is obtained.

In step S403, based on the determined priority relationship, the first signal is measured by the first UE in the first unit.

Here, for example, the first signal may be a SL PRS.

In an embodiment of the present disclosure, a method performed by a first user equipment (UE) in a communication system, including: receiving configuration information for a first unit used for a first signal measurement; obtaining a priority relationship between a first signal and a second signal and/or channel, and/or obtaining a priority relationship between the first signal of a second UE and the first signal of a third UE; and measuring the first signal in the first unit based on the determined priority relationship.

In an embodiment of the present disclosure, wherein the priority relationship between the first signal and the second signal and/or channel includes: in case that the first UE is able to process the first signal and the second signal and/or channel in parallel, the priority of the first signal is the same as the priority of the second signal and/or channel; or the priority relationship between the first signal and the second signal and/or channel is determined based on a pre-configured priority value of the first signal and a pre-configured priority value of the second signal and/or channel; or the priority relationship between the first signal and the second signal and/or channel is determined based on the received priority value of the first signal and a pre-configured priority value of the second signal and/or channel; or the priority relationship between the first signal and the second signal and/or channel is determined based on the first UE capability; or the priority relationship between the first signal and the second signal and/or channel is based on information on UE capability and the received information with the priority.

In an embodiment of the present disclosure, wherein determining the priority relationship between the first signal and the second signal and/or channel includes: the first UE reporting channel occupancy information, determining the priority relationship between the first signal and other signals and/or channels based on the channel occupancy information and a threshold value associated with the channel occupancy in case that the first UE receives the threshold value associated with the channel occupancy; or determining that the first signal is higher priority the another signals and/or channels in case that the UE does not receive the threshold value associated with the channel occupancy.

In an embodiment of the present disclosure, wherein determining the priority relationship between the first signal and the second signal and/or channel includes: determining that the first signal is lower priority than the second signal and/or channel; or in case that a threshold value associated with the priority of the second signal and/or channel is received, determining the priority relationship between the first signal and the second signal and/or channel based on the threshold value associated with the priority of the second signal and/or channel and information with the priority value of the first signal; or determining that the first signal is higher priority than the second signal and/or channel in case that the threshold value associated with the priority of the second signal and/or channel is not received; or determining that the first signal is lower priority than Physical Side Feedback Channel (PSFCH).

In an embodiment of the present disclosure, wherein a priority value of the first signal of the second UE and a priority value of the first signal of the third UE are configured based on a time order in which requests arrival at network node, and the requests are sent by the second UE and the third UE to configure the first unit; or the priority value of the first signal of the second UE and the priority value of the first signal of the third UE are configured based on moving speeds of the second UE and the third UE; or the priority value of the first signal of the second UE and the priority value of the first signal of the third UE are configured based on time information on the time corresponding to the first signals of the second UE and the third UE.

In an embodiment of the present disclosure, wherein measuring the first signal in the first unit based on the determined priority relationship of the above includes: determining resource for the first signal transmission based on the determined priority relationship, and measuring the determined resource in the first unit.

In an embodiment of the present disclosure, wherein determining the resource for the first signal transmission based on the determined priority relationship includes: when the first signal of the second UE is higher priority than the first signal of the third UE and/or the priority of the second signal and/or channel, resources reserved for the first signal of the third UE and/or the second signal and/or channel are selected for the first signal of the second UE, and resource re-evaluation of the selected resources is triggered; or when the first signal of the second UE is lower priority than the first signal of the third UE and/or the priority of the second signal and/or channel, the resource reserved for the first signal of the second UE is selected for the first signal of the third UE and/or the second signal and/or channel, and the resource re-evaluation of the selected resource is triggered.

In an embodiment of the present disclosure, wherein in case that one or more first signals overlap in time with multiple non-overlapped second signals and/or channels: if at least one first signal of the one or more first signals is prioritized over all second signals and/or channels, resources reserved for the multiple non-overlapped second signals and/or channels are selected for the one or more first signals, and resource re-evaluation of the selected resources is triggered; or if at least one second signal and/or channel is prioritized over all first signals, the resources reserved for the one or more first signals are selected for the multiple non-overlapped second signals and/or channels, and resource re-evaluation of the selected resources is triggered.

In an embodiment of the present disclosure, wherein in case that one first signal overlaps in time with one or more non-overlapped second signals and/or channels: if the one first signal is prioritized over all the second signals and/or channels, resources reserved for the one or more non-overlapped second signals and/or channels are selected for the one first signal, and resource re-evaluation of the selected resources is triggered; if at least one non-overlapped second signal and/or channel of the one or more non-overlapped second signals and/or channels is prioritized over the one first signal, resource reserved for one first signal is selected for the one or more non-overlapped second signals and/or channels, and resource re-evaluation of the selected resources is triggered.

In an embodiment of the present disclosure, wherein the first signal is a signal or a signal resource or a signal resource set for positioning, wherein the first unit includes at least one of: a measurement gap for measuring the first signal; a processing window for measuring the first signal; a time domain unit for measuring the first signal; a duration L starting from a starting position S of resources used for the first signal transmission, or a length of time domain resources occupied by M first signals starting from the starting position S of the resources used for the first signal transmission, wherein S, L and M are real numbers greater than 0.

In an embodiment of the present disclosure, further including: when the first signal of the second UE overlaps with the first signal of the third UE or the second signal and/or channel in time domain and/or frequency domain resources: in case that the first signal of the second UE is higher priority than the second signal and/or channel or the first signal of the third UE, the first UE is expected to receive the first signal of the second UE; or in case that the first signal is lower priority than the second signal and/or channel, the first UE is expected to receive the second signal and/or channel and/or drops all or part of the first signals; or in case that the first signal of the second UE is lower priority than the first signal of the third UE, the first UE performs at least one of the following: being not required to receive the first signal of the second UE, drop all or part of the first signals of the second UE, extending a measurement duration of the first unit, the first UE indicating the dropped number of first signals of the second UE to the second UE, and the first UE indicating an identify and/or a time domain resource symbol index of the dropped first signal of the second UE to the second UE; or in case that the first signal of the second UE has the same priority as that of the first signal of the third UE, resource is reserved for the first signal of any one of the second UE and the third UE, and the resource re-evaluation of the first signal of the rest UE is triggered, or according to time of the timer in the configuration information of the first signals of the second UE and the third UE, the resource is reserved for the first signal of the UE with the shortest time of the timer, and the re-evaluation of resource is triggered for the rest UE.

In an embodiment of the present disclosure, wherein when a ratio of the dropped number of first signals of the second UE to the number of configured or pre-configured first signals of the second UE is greater than a third threshold value, the length L of the measurement duration is extended, wherein the measured first signal does not contain the dropped first signal.

In an embodiment of the present disclosure, further including: if the first signal of the second UE is lower priority than the first signal of the third UE, the first signal of the second UE on overlapping time domain resources and/or overlapping frequency domain resources is muted and/or deactivated by the second UE; the second UE configures or activates the same number of the first signals as that of the dropped first signals of the second UE indicated by the first UE, or reserves the same number of the first signals resource as that of the dropped first signals of the second UE indicated by the first UE.

In an embodiment of the present disclosure, further including: the first UE reports measurement result of the first signal to a network node, wherein the measurement result is reported on the first Physical Sidelink Shared Channel (PSSCH), or the first Physical Uplink Shared Channel (PUSCH), or the first Physical Sidelink Control Channel (PSCCH), or the first Physical Uplink Control Channel (PUCCH) after the last time unit of the first unit; or in case that the first signal measurement is completed in first N time units of the first unit, the measurement result is reported on the PSSCH or the PUSCH or the PSCCH or the PUCCH before the end of the first unit from the (N+1)th time unit; or in case that the first signal is measured in the Xth first unit, the measurement result is reported after the Xth first unit, wherein X is an integer greater than or equal to 1, and the measurement result includes measurement result of the Xth first unit; or after measuring the first signal using the last time unit of the first unit, the first UE requests uplink transmission resource, and reports the measurement result through PSSCH or PUSCH or PSCCH or PUCCH on the configured resource.

In an embodiment of the present disclosure, wherein the priority of the measurement result reporting is the same as the highest priority among the priorities of multiple first signals measured in P first units, wherein P is an integer greater than 1, or in case that the measurement result is obtained based on measurement of multiple first units, the priority of the measurement result reporting is the same as the highest priority in the first signals in the last first unit in which the measurement is performed.

In an embodiment of the present disclosure, a User Equipment (UE) in a wireless communication system, the UE including: a transceiver, configured to receive and transmit a signal; and a controller coupled with the transceiver and configured to control the UE to perform the method of any one of the above.

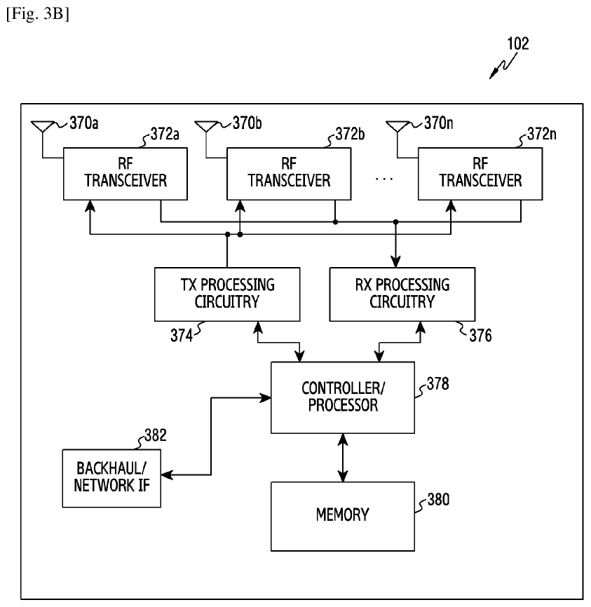

FIG. 5 illustrates a structure of a UE according to an embodiment of the disclosure.

As shown in FIG. 5, the UE according to an embodiment may include a transceiver 510, a memory 520, and a processor 530. The transceiver 510, the memory 520, and the processor 530 of the UE may operate according to a communication method of the UE described above. However, the components of the UE are not limited thereto. For example, the UE may include more or fewer components than those described above. In addition, the processor 530, the transceiver 510, and the memory 520 may be implemented as a single chip. Also, the processor 530 may include at least one processor. Furthermore, the UE of FIG. 5 corresponds to the UE 111, 112, 113, 114, 115, 116 of the FIG. 1, respectively.

The transceiver 510 collectively refers to a UE receiver and a UE transmitter, and may transmit/receive a signal to/from a base station or a network entity. The signal transmitted or received to or from the base station or a network entity may include control information and data. The transceiver 510 may include a RF transmitter for up-converting and amplifying a frequency of a transmitted signal, and a RF receiver for amplifying low-noise and down-converting a frequency of a received signal. However, this is only an example of the transceiver 510 and components of the transceiver 510 are not limited to the RF transmitter and the RF receiver.

Also, the transceiver 510 may receive and output, to the processor 530, a signal through a wireless channel, and transmit a signal output from the processor 530 through the wireless channel.

The memory 520 may store a program and data required for operations of the UE. Also, the memory 520 may store control information or data included in a signal obtained by the UE. The memory 520 may be a storage medium, such as read-only memory (ROM), random access memory (RAM), a hard disk, a CD-ROM, and a DVD, or a combination of storage media.

The processor 530 may control a series of processes such that the UE operates as described above. For example, the transceiver 510 may receive a data signal including a control signal transmitted by the base station or the network entity, and the processor 530 may determine a result of receiving the control signal and the data signal transmitted by the base station or the network entity.

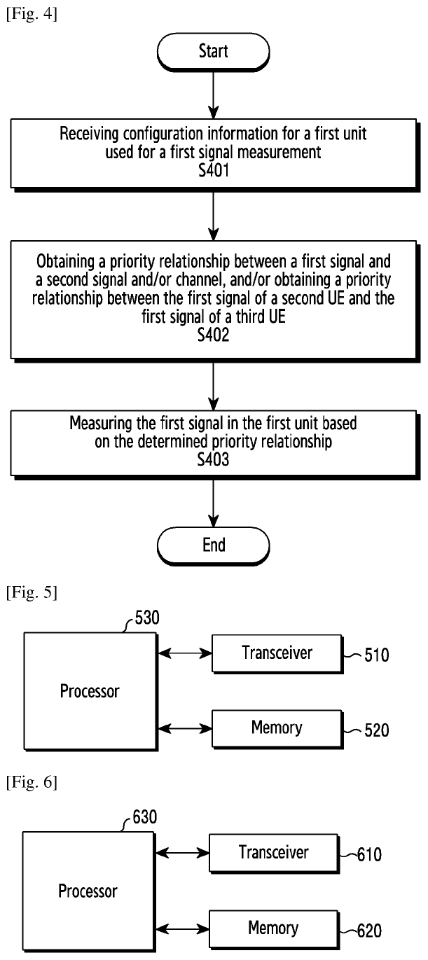

FIG. 6 illustrates a structure of a base station according to an embodiment of the disclosure.

As shown in FIG. 6, the base station according to an embodiment may include a transceiver 610, a memory 620, and a processor 630. The transceiver 610, the memory 620, and the processor 630 of the base station may operate according to a communication method of the base station described above. However, the components of the base station are not limited thereto. For example, the base station may include more or fewer components than those described above. In addition, the processor 630, the transceiver 610, and the memory 620 may be implemented as a single chip. Also, the processor 630 may include at least one processor. Furthermore, the base station of FIG. 6 corresponds to base station (e.g., BS 101, 102, 103 of FIG. 1).

The transceiver 610 collectively refers to a base station receiver and a base station transmitter, and may transmit/receive a signal to/from a terminal(UE) or a network entity. The signal transmitted or received to or from the terminal or a network entity may include control information and data. The transceiver 610 may include a RF transmitter for up-converting and amplifying a frequency of a transmitted signal, and a RF receiver for amplifying low-noise and down-converting a frequency of a received signal. However, this is only an example of the transceiver 610 and components of the transceiver 610 are not limited to the RF transmitter and the RF receiver.

Also, the transceiver 610 may receive and output, to the processor 630, a signal through a wireless channel, and transmit a signal output from the processor 630 through the wireless channel.

The memory 620 may store a program and data required for operations of the base station. Also, the memory 620 may store control information or data included in a signal obtained by the base station. The memory 620 may be a storage medium, such as read-only memory (ROM), random access memory (RAM), a hard disk, a CD-ROM, and a DVD, or a combination of storage media.

The processor 630 may control a series of processes such that the base station operates as described above. For example, the transceiver 610 may receive a data signal including a control signal transmitted by the terminal, and the processor 630 may determine a result of receiving the control signal and the data signal transmitted by the terminal.

It will be understood by those skilled in the art that each step recorded in the method embodiments of the present disclosure may be performed in a different order than shown, for example, in parallel or in the reverse order. Furthermore, the method embodiments of the present disclosure may also include additional steps and/or omit the steps shown.

Those skilled in the art will understand that the illustrative embodiments described above are described herein and are not intended to be limiting. It should be understood that any two or more of the embodiments disclosed herein may be combined in any way. In addition, other embodiments may be utilized and other changes may be made without departing from the spirit and scope of the subject matter presented herein. It will be readily understood that aspects of the invention of the present disclosure, as generally described herein and shown in the accompanying drawings, may be arranged, substituted, combined, separated and designed in various different configurations, all of which are contemplated herein.

Those skilled in the art will understand that the various illustrative logical blocks, modules, circuits, and steps described herein may be implemented as hardware, software, or a combination of both. In order to clearly illustrate this interchangeability between hardware and software, various illustrative components, blocks, modules, circuits, and steps are generally described in the form of function sets. Whether such a function set is implemented as hardware or software depends on the specific disclosure and design constraints imposed on the overall system. Those skilled in the art may implement the described function set in different ways for each specific disclosure, but such design decisions should not be interpreted as causing a departure from the scope of this disclosure.

The illustrative logic blocks, modules, and circuits described in this disclosure may be implemented as a general-purpose processor, a Digital Signal Processor (DSP), an Application Specific Integrated Circuit (ASIC), Field Programmable Gate Array (FPGA) or other programmable logic devices, discrete gate or transistor logic, discrete hardware components, or any combination thereof designed to perform the functions described herein. The general-purpose processor may be a microprocessor, but in the alternative, the processor may be any conventional processor, controller, micro-controller, or state machine. The processor may also be implemented as a combination of computing devices, such as a combination of a DSP and a microprocessor, a plurality of microprocessors, one or more microprocessors cooperating with a DSP core, or any other such configuration.

The steps of a method or algorithm described in this disclosure may be embodied directly in hardware, in a software module executed by a processor, or in a combination of the two. Software modules may reside in RAM memory, flash memory, ROM memory, EPROM memory, EEPROM memory, registers, hard disks, removable disks, or any other form of storage media known in the art. An exemplary storage medium is coupled to a processor to enable the processor to read and write information from/to the storage medium. In the alternative, the storage medium may be integrated into the processor. The processor and storage medium may reside in an ASIC. The ASIC may reside in the user terminal. In the alternative, the processor and the storage medium may reside as discrete components in the user terminal.

In one or more exemplary designs, the described functions may be implemented in hardware, software, firmware, or any combination thereof. If implemented in software, each function may be stored on or transmitted by a computer-readable medium as one or more instructions or codes. Computer-readable media include both computer storage media and communication media, and the latter includes any media that facilitates the transfer of computer programs from one place to another. The storage media may be any available medium that can be accessed by a general-purpose or special-purpose computer.

1-15. (canceled)

16. A first user equipment (UE) in a wireless communication system, the first UE comprising:
a transceiver;
a memory storing one or more computer programs; and
one or more processors communicatively coupled to the transceiver and the memory,
wherein the one or more programs include computer-executable instructions that, when executed by the one or more processors individually or collectively, cause the first UE to:
transmit, to a second UE, a first sidelink (SL) positioning reference signal (PRS) on a first resource in a first resource pool, and
transmit, to the second UE, a second SL PRS and a physical sidelink shared channel (PSSCH) on a second resource in a second resource pool,
wherein a priority value for the first SL PRS is provided by first sidelink control information (SCI) or a first high layer signaling, and
wherein a priority value for the second SL PRS is same with a priority value for the PSSCH.

17. The first UE of claim 16,
wherein the first resource pool is a dedicated SL PRS resource pool, and
wherein the second resource pool is a shared SL PRS resource pool.

18. The first UE of claim 16,
wherein the first resource for an SL PRS is reserved based on a second SCI or a second high layer signaling.

19. The first UE of claim 16,
wherein the first resource for an SL PRS reservation is based on a channel busy ratio (CBR).

20. A second user equipment (UE) in a wireless communication system, the second UE comprising:
a transceiver;
a memory storing one or more computer programs; and
one or more processors communicatively coupled to the transceiver and the memory,
wherein the one or more programs include computer-executable instructions that, when executed by the one or more processors individually or collectively, cause the second UE to:
receive, from a first UE, a first sidelink (SL) positioning reference signal (PRS) on a first resource in a first resource pool, and
receive, from the first UE, a second SL PRS and a physical sidelink shared channel (PSSCH) on a second resource in a second resource pool,
wherein a priority value for the first SL PRS is provided by first sidelink control information (SCI) or a first high layer signaling, and
wherein a priority value for the second SL PRS is same with a priority value for the PSSCH.

21. The second UE of claim 20,
wherein the first resource pool is a dedicated SL PRS resource pool, and
wherein the second resource pool is a shared SL PRS resource pool.

22. The second UE of claim 20,
wherein the first resource for an SL PRS is reserved based on a second SCI or a second high layer signaling.

23. The second UE of claim 20,
wherein the first resource for an SL PRS reservation is based on a channel busy ratio (CBR).

24. A method performed by a first user equipment (UE) in a wireless communication system, the method comprising:
transmitting, to a second UE, a first sidelink (SL) positioning reference signal (PRS) on a first resource in a first resource pool; and
transmitting, to the second UE, a second SL PRS and a physical sidelink shared channel (PSSCH) on a second resource in a second resource pool,
wherein a priority value for the first SL PRS is provided by first sidelink control information (SCI) or a first high layer signaling, and
wherein a priority value for the second SL PRS is same with a priority value for the PSSCH.

25. The method of claim 24,
wherein the first resource pool is a dedicated SL PRS resource pool, and
wherein the second resource pool is a shared SL PRS resource pool.

26. The method of claim 24,
wherein the first resource for an SL PRS is reserved based on a second SCI or a second high layer signaling.

27. The method of claim 24,
wherein the first resource for an SL PRS reservation is based on a channel busy ratio (CBR).

28. A method performed by a second user equipment (UE) in a wireless communication system, the method comprising:
receiving, from a first UE, a first sidelink (SL) positioning reference signal (PRS) on a first resource in a first resource pool; and
receiving, from the first UE, a second SL PRS and a physical sidelink shared channel (PSSCH) on a second resource in a second resource pool,
wherein a priority value for the first SL PRS is provided by first sidelink control information (SCI) or a first high layer signaling, and
wherein a priority value for the second SL PRS is same with a priority value for the PSSCH.

29. The method of claim 28,
wherein the first resource pool is a dedicated SL PRS resource pool, and
wherein the second resource pool is a shared SL PRS resource pool.

30. The method of claim 28,
wherein the first resource for an SL PRS is reserved based on a second SCI or a second high layer signaling.
